(19) United States
(12) Patent Application Publication
(10) Pub. No.: US 2011/0112686 A1
(43) Pub. Date: May 12, 2011

(54) DEVICES AND METHODS AND SYSTEMS FOR DETERMINING AND/OR INDICATING A MEDICAMENT DOSAGE REGIME

(76) Inventors: James S. Nolan, San Diego, CA (US); Bruce David Steel, San Diego, CA (US)

(21) Appl. No.: 12/943,878

(22) Filed: Nov. 10, 2010

Related U.S. Application Data
(60) Provisional application No. 61/259,915, filed on Nov. 10, 2009.

(51) Int. Cl. G06F 17/00

(52) U.S. Cl. 700/244

(57) ABSTRACT

In one aspect, the disclosure is directed to a device for determining and/or indicating a medicament dosage regime. The device may include a housing, a processor, a memory, an input device, and/or an indication device. The dosage determining and/or indicating device is configured for receiving user, e.g., patient, information, medicament information, and/or dosage information, and using that information to determine one or more of the following: the type of medicament recommended to be administered, how often and when the medicament should be administered, how much of the medicament should be administered, potential problematic cross reactivity information, and/or patient compliance information, such as when the when the medicament was last administered, when the medicament is next due to be administered, when a recommended administration was not administered, and the like. The device may further be coupled to an alarm to indicate when a dosage of the medicament is to be delivered.

### BACKGROUND

Unhealthy conditions, such as those brought on by disease, typically require the administration of medication as a means of treating the unhealthy condition(s) or ameliorating an adverse side effect thereof. Often, such medication is to be administered periodically over a prolonged period of time. So being, a suitable medication may be formulated in tablet form and stored in a container prior to administration. Typically, a health care practitioner prescribes the medication, a pharmacist fills the prescription by filling a suitable container with the prescribed medication, and delivers it to a subject in need thereof with the recommended dosing regime set forth on a label attached to an outer surface of the storage container.

Problems arise, however, when the labels are not printed clearly, are improperly attached, and/or space is limited and adequate warnings and/or cross reactivities are not capable of being included on the associated label. These problems can be exacerbated in situations where patient compliance is necessary to ensure the success of treatment and the restoration of health. Further, such problems can be life threatening in situations where a subject is in need of a multiplicity of medications one or more of which may have an adverse cross reactivity with another medication the subject is in need of but is unaware of the adverse effects of combining the two or more medications. For instance, one such problem arises where a medication is to be administered to a subject in the middle of the night, or in the early morning hours, and the subject must awake from sleep and self-administer the medication. In such situations, mistakes in dosing may occur because of the subject's sleepiness and/or dim lighting, and/or other factors that may make reading the dosing label difficult. As indicated above, such inadvertent dosing and/or re-dosing may be life threatening.

Accordingly, there is a need in the art for a mechanism as well as a method for its use which overcomes the problems, such as inadvertent dosing and/or cross reactivities, associated with the current manner in which medications are typically stored prior to administration. The devices and methods of their use provided herein meet these and other such needs in the art.

### SUMMARY

In one aspect, the disclosure is directed to a device for determining and/or indicating a medicament dosage regime. For instance, in certain embodiments, a hand-held dosage determining and/or indicating device is provided. The device may include a housing, a processor, a memory, an input device, an indication device, a GPS device, a gyroscope, and/or a suitable power supply. The housing may be configured for containing the processor and memory and may further be configured for containing or otherwise being associated with an input and an indication device, e.g., a display device, as well as a GPS device, gyroscope, and a power supply. Accordingly, the bounds of the housing may directly contain one or more of the processor, memory, input device, indication device, GPS device, gyroscope, and/or power supply; or one or more of these elements may be independent there from and otherwise associated with the housing and/or otherwise contained therein. For instance, in some embodiments, at least the processor and memory may be contained within a client, which client may be associated with the housing of the device.

The dosage determining and/or indicating device may be configured for receiving user, e.g., patient, information, medicament information, and/or dosage information, or the like, and further may be configured for using that information to determine one or more of the following: a patient characteristic, a patient symptom, the type of medicament recommended to be administered, how often and when the medicament should be administered, how much of the medicament should be administered, potential problematic cross reactivity information, and/or patient compliance information; such as where and/or when the medicament was last administered, when the medicament is next due to be administered, when a recommended administration was not administered, and the like. The dosage determining and/or indicating device may further be coupled to an alarm to indicate, for instance, when a dosage of the medicament is to be delivered and/or to indicate when a dosage of the medicament is about to be inappropriately delivered. Additionally, the dosage determining and/or indicating device may include a locking mechanism so as to prevent the administration of a dosage, such as when it would be inappropriate for such a dosage to be delivered. In certain instances, the dosage determining and/or indicating device of the disclosure may be configured as a container, such as a tablet container, as described below, and/or may be configured as a personalized computing system, such as a personal data assistant (PDA), mobile phone, computer, and the like.

In another aspect, the disclosure is directed to a device for containing and/or dispensing a medication, such as a medication in tablet or liquid form, wherein the device is associated with a dosage indicator, such as that described above. The device may include a receptacle, such as a container, that is configured for receiving and containing the medication for a prolonged period of time, such as in between dosages during a treatment regime, and may further be configured for dispensing a determined dosage of the medication at a determined time and/or periodicity. The device may additionally include an opening, such as a lid, that is configured for being opened and/or closed, or otherwise removably associated with the container. In certain embodiments, one or both of the container and lid (if provided) may include the indicator, which indicator is configured for indicating one or more of: the type of medication contained, when and/or how much of the medicament is to be administered, when the container was opened, when the medicament was administered, and/or may store and indicate other pertinent patient information, such as name, age, weight, sex of the patient, patient history, health history, medication history, and/or cross reactivity information. In certain instances, the container and/or lid (if provided) may include a GPS and/or gyroscope function so that the location and/or position of the container, especially during usage, may be determined and/or tracked. In some embodiments, the device may further include a patient identifying and/or locking mechanism that identifies the patient authorized to use the device and/or prevents the opening of the device, e.g., the removal of lid from the container, for instance, if the patient has not been appropriately identified, and/or in between the recommended dosage times, and/or if there is an unresolved, potentially dangerous cross reactivity identified, and/or it is determined that the container has been lost or stolen.

In an additional aspect, a system is provided. The system may include a device for containing and/or dispensing a medication, as described above, and may additionally include one or a plurality of user clients, such as clients that may include user interfaces, which user clients may be connected to the container directly and/or one another by a network. A client therefore may contain a processor, memory, and programming sufficient for performing one or more of the following functions: receiving, processing, generating, and/or transmitting data. One or more user interfaces may be associated with the one or more user clients. For instance, in certain instances, two or more, such as three, user clients with one or more user interfaces may be provided. For example, where a plurality of user clients are provided, the user clients may include one or more of: a primary user client with a primary user interface (e.g., a client to be associated with the container), a secondary user client with a secondary user interface (e.g., a first server), a tertiary user client with a tertiary user interface (e.g., a second server), and the like (e.g., additional computers and/or servers). Accordingly, in certain embodiments, a system is provided, wherein the system includes a container that is associated with a primary user client, one or more additional user clients, e.g., a secondary and/or tertiary user client, and a network connecting them. In this instance, the term container refers to one or both of a container and a lid.

A primary user interface may be an interface provided to a user of the container, e.g., a user of the contained medicament. The primary user interface may be provided at a client that is associated with a container of the disclosure. In certain instances, the primary user interface may be associated with a client that is associated with an auxiliary device of the primary user, such as a PDA (personal digital assistant), personal computer, mobile phone, and the like, A secondary user interface may be a user interface that is provided at a secondary client to a user of the data generated by the primary client. In certain embodiments, the secondary client may access and manipulate the data provided by the primary user client, and may interact directly with the primary user client at the container. A tertiary user interface may be a user interface provided at a tertiary client, which user interface may have access to the data generated by the primary user client and/or data generated by the secondary user client. In certain embodiments, the tertiary user interface may or may not have the ability to access and/or the ability to manipulate the data provided at the primary and/or secondary user clients.

Accordingly, in one aspect a method is provided. The method includes generating a page for presentation at an interface, such as at a user interface. The page may include one or more requests for data, such as data pertaining to user, e.g., patient, information, medicament information, user dosage and/or use information, and the like. The method may further include providing the generated page, for instance, at the user interface at a primary user client, thereby prompting the user, e.g., patient or other designated user, to enter data thereby. The primary user interface may be provided at a primary user client, which client is associated with a container of the disclosure, or may be provided at another suitable device, such as a personal computer of the primary user, PDA, mobile phone, or the like. In such an instance, the auxiliary device may be configured for communicating with the container to transmit and/or receive information therewith. Hence, a primary user may interact with the primary user interface, which user interface is provided at a primary client, e.g., container, of the disclosure. The primary user client may generate one or more queries to be displayed on the primary user interface, which queries act to elicit the entry of primary user, e.g., patient, information. Additionally, the primary user client may contain programming so as to receive, determine, and/or track data pertaining to the primary user's interaction with the container as well as to transmit that data to one or more secondary and/or tertiary users, such as via a network.

Hence, where a multiplicity of user interfaces are provided, e.g., primary, secondary, and/or tertiary user interfaces that are associated with primary, secondary, and/or tertiary clients, the method may additionally include making primary user data available to the one or more of additional user interfaces, such as via a network. Hence, the method may include generating one or more pages for presentation at the additional user interface(s). In this regard, the additional user interfaces may include a user interface provided at a client at a secondary user's location, such as at a Doctor's office, health care provider's office, and the like; and/or a user interface provided at client at a tertiary user's location, such as at an insurance company, a federal or other government agency, a monitoring service, and/or the like. The one or more pages may provide data that may be accessed by the secondary and/or tertiary user, e.g., doctor's office, health care provider, etc. via the clients connection to the network. The data to be provided may be raw data or compiled data, such as data entered by a primary user of the container and/or data generated by the programming of the primary user client of the container, such as container interaction or usage data.

For instance, the data may be primary user entered data or other data generated by the primary user's interaction with the container, for instance, use data. Such use data may include one or more of: the opening and closing of the container, e.g., removal of the lid, time and/or location and/or position of the container at the time of opening or closing, the weight differential between opening and closing, dosage data, attempted access data, identity of attempted accessor, biological status information of accessor (e.g., heart rate, blood pressure, body temperature, and the like), lock out data, updated and/or determined dosage data, cross reactivity data, and the like. The data may be collated and compiled by the processor of a client, e.g., a primary client, or the like, and may be provided to a secondary user client, such as a client of a monitoring entity, e.g., a doctor. The data may be collated and/or compiled by the programming of the client associated with the container, and may be presented as statistical information, for instance, which in turn may be employed so as to determine usage trending and/or to determine and/or manage risk factors. In certain instances, such data may be manipulated by the secondary and/or tertiary client, and/or the secondary or tertiary client may then interact with the primary client so as to manipulate the functioning parameters of the container, e.g., via the primary user client.

Accordingly, the secondary user may employ a secondary client to not only access the data, e.g., via a secondary user interface, but may also employ the secondary client in a manner sufficient to interact with the programming of the primary user client, e.g., the client associated with the container device, so as to modify the use parameters of the container. For instance, in certain instances, a secondary user may access the data and make one or more decisions and/or take one or more actions in respect thereof. For example, the secondary user may interact with the programming of the primary client that is associated with the container via the network. Some of the actions that may be taken include changing the dosage amount, periodicity of dosage, updating stored medical and cross reactivity information, modifying opening and/or locking out parameters, changing patient identification information, and the like. In a manner such as this, a secondary user may access the data of the primary user's interaction with the container and in response thereto modify ongoing use parameters.

Further, in certain instances, it may be beneficial for the primary user client or secondary user (or secondary user client directly) to communicate with a 3^{rd} party in response to the use data or secondary user's interaction with the generated use data. Such an instance could occur where the primary user's usage data tracked and/or communicated by the primary client of the container signifies a particular risk or danger factor. In such an instance, the secondary user, such as a monitoring service, may analyze the obtained data, determine there is a risk to the primary user's health due to their interaction with the container, and in response thereto contact a governmental agency, such as a fire, police department, or other health care organization, for instance, to notify them of the determined risk factor. Of course, in certain instances, the primary client may interact direct with the 3^{rd} party without the mediation of the secondary user or secondary user client.

It is to be noted with respect to the above description, although only one container and therefore only one primary user interface and/or one primary user client is provided, in certain embodiments, a multiplicity of containers and/or primary user interfaces and/or primary user clients may be provided, and the data entered and/or generated thereby may be compiled and/or collated and provided to a secondary and/or tertiary user client via the network. For instance, a plurality of containers may be provided where the containers each contain an experimental medicament or such (e.g., placebo) which is currently undergoing examination, such as clinical evaluation. The containers, therefore, may be provided to members of the study group, and their individual and/or collective usage information, e.g., their interactions with the containers, may be tracked, determined, collated, compiled, and provided either as raw data or

Accordingly, in one aspect, a method for monitoring one or more primary users' interaction with one or more containers is provided. For instance, a method for monitoring and/or otherwise determining a container user's compliance with a medicament usage parameter is provided. The method may include providing a medicament container, as described above, to one or more users, e.g., test subjects, and monitoring the subject's interaction with the container. Where two or more containers are provided to one or more primary users, the method may include generating interaction data (e.g., usage data) for each container and/or user and comparing the interaction data so as to generate usage data. The usage data may then be employed to make various determinations pertaining to usage, such as to determine statistical information regarding medicament usage and compliance. The usage data may be determined, generated, or otherwise received by the programming of a client associated with the container and/or by the programming of a client of a secondary and/or tertiary user. The usage data may include the interaction of a single user with a multiplicity of containers, the interaction of a multiplicity of users with a single container, a multiplicity of users with a multiplicity of containers, or the interaction of a single user with a single container. The usage data may then be processed and/or transmitted (or transmitted and/or processed) to one or more secondary and/or tertiary users.

In another aspect, a method of monitoring the usage of a container containing a medicament is provided. The monitoring may be performed for the purpose of determining usage information or as a means for ensuring appropriate operation parameters (e.g., usage) of the container by the primary user, for instance, to ensure the safety of a primary user of the container. Accordingly, the method may include the provision of a medicament container of the disclosure to a primary user of the container, e.g., a patient. The medicament container may include a primary client that is configured for determining the interactions of a primary user with the container and thereby generating usage data. The primary client may further be configured for determining or otherwise enforcing the usage parameters for the container. The primary client of the medicament container may be associated with one or more of a secondary and/or tertiary client via a network. The primary client generates or otherwise transmits use data to the secondary and/or tertiary client. The secondary or tertiary client (and/or a secondary user or tertiary user thereof, respectively) monitors the use data, and if a predetermined event is identified, the secondary or tertiary client (or user, e.g., a live observer) responds in one of a multiplicity of ways. For instance, the initiation of a response protocol may include the receiving of use data by the secondary or tertiary client, the compiling and processing of that data to determine a result, and the comparison of that result to one or more predetermined conditions such that if the result is within the range of the predetermined conditions a response protocol is engaged. A multiplicity of response protocols may be engaged, for example, the secondary or tertiary client (or users) may cause an alarm signal to be transmitted to the device or a third party, may cause a lock out or open signal to be transmitted to the device to ensure the lockdown or opening of the device, may contact the user of the device via phone or e-mail, or may initiate another predetermined response protocol. In this manner, the usage of the container may be monitored and/or tracked and if necessary, e.g., in times of emergency, the container can be locked down and rescue personal notified.

In some variations one or more of the following can optionally be included. The primary user interface may be provided at a plurality of primary clients. Where a plurality of primary clients is provided the secondary and/or tertiary clients (e.g., servers) compile the use data of the clients and generates outcome or result data which may then be employed to determine a specific response protocol.

The programming of the server may be configured so as to perform a probability assessment of the use data so as to determine the probability that an actual response is necessary, which probability may then be employed by the server or another party so as to weight and/or select the appropriate response from a protocol of responses. For instance, where the use data pertains to a designation of a predicted outcome, the use data may be weighed against past actual outcome and/or actual response data, e.g., stored within a memory of the server, so as to determine the probability that a present actual response is necessary and if so which response is most appropriate. For instance, where a specific use of a container is identified as a potential alarm and the potential alarm is assessed to be an actual alarm that generates a particular predetermined response that is implemented as an actual response, and it is later determined that the potential alarm and/or predetermined response either did or did not corresponded to an actual alarm and/or an appropriate actual response thereto, a future potential alarm and/or future suggested response that is similar to the past potential alarm and/or response that was actually implemented may be given more or less weight, respectively, in determining whether the current situation amounts to an actual alarm and/or what the current actual response should be. In a manner such as this, a current potential alarm and suggested response can be weighted to determine the probability that an actual alarm is present and if so weight the potential responses thereto or to otherwise determine the appropriateness (or potential appropriateness) of the available responses. The determination of which response will be most appropriate and/or actually implemented may be performed as an actual selection, e.g., by the secondary or tertiary client, that is implemented automatically; or it may be provided to a user of the secondary and/or tertiary client as a suggestion, which may then be implemented by the user (e.g., by acting on their own or by interacting with the secondary or tertiary client to implement the suggested response).

In an interrelated aspect, the system as described above is provided. The system includes a primary client having a primary user interface and at least a secondary client having a secondary user interface. The primary client is associated with a container, such as a pill container. The primary client can be any suitable device for generating and/or displaying a generated page at a user interface, such as those commonly known in the art, including a computer, an electronic game counsel, a telephone, a personal data assistant (PDA), and the like. The primary client may be configured for receiving user entered data, generating use data, processing, storing the same, and/or transmitting that data to and/or receiving data (e.g., instructions) from the secondary client, e.g., a server. Accordingly, the system may include a secondary client that is a server. The server may be implemented as one or more processors, such as a computer, a server, and the like. The primary client may be coupled to the server through a network. The server is configured for receiving data from the primary client, processing and/or correlating that data, and using that data so as to determine and/or implement a response protocol. The response protocol may be any appropriate type of response, such as the transmission of a communication, the signaling of an alarm, the initiation of an action, or the request for a secondary user instruction prior to the implementation of an action. Hence, the response may be automatically initiated by the server, e.g., as an instruction sent via the network to the primary client so as to effectuate a change therein, or the response protocol may simply suggest an appropriate response and present that suggestion at a user interface of the secondary client and/or request secondary user confirmation before initiating the suggested response action. The system may additionally include a tertiary client that may also be coupled to the server system through the network.

For instance, in one implementation a system is provided wherein the system includes at least one processor; and at least one memory. The at least one processor and the at least one memory provide operations. The operations provided include generating a page for presentation at one or more user interfaces. For instance, the page may include queries, or answers to the same, or use data, or a suggested response data, or the like. The operations further include providing the generated page and receiving input in response thereto. The operations may additionally include the implementation of an action in response to the input data. The implementation of an action in turn may effectuate a change in the memory, which in turn can effectuate a change in the operation, and consequently a modification of future actions.

In another interrelated aspect, a computer readable medium is provided. The computer readable medium may contain code, which when executed by a processor provides operations. The operations provided include those described above, such as the generating a page for presentation at a user interface, the receipt of input in response thereto, and the implementation of actions in response to the input data.

Accordingly, the implementation of the methods of the disclosure may include: the use of one or more clients (which may comprise one or more of a processor and memory, computer, a telephone, a personal data assistant (PDA), a server, or the like), upon which the generated page is displayed; a server; and/or a network connecting the client and/or the server. Hence, articles are described that comprise a tangibly embodied machine-readable medium embodying instructions that, when performed, cause one or more machines (e.g., containers, computers, etc.) to result in operations described herein. Similarly, computer systems are also described that may include a processor and a memory coupled to the processor. The memory may include one or more programs that cause the processor to perform one or more of the operations described herein.

In a further aspect, the disclosure is directed to a method of using an indicator device and/or an associated medicament containing device, as described herein, e.g., for the containment and storage of a medication, such as in a treatment regime for the promotion of a healthy condition and/or prevention or treatment of an unhealthy condition. Kits including the devices of the disclosure as well as instructions for their methods of use are also provided herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

FIG. 1 is a depiction of an indicator of the disclosure as described herein.

FIG. 2 is a depiction of an interactive, touch screen display for use in accordance of the devices and methods disclosed herein.

FIG. 3 illustrates an exemplary container, lid, and indicator of the disclosure.

FIG. 4 illustrates a system of the disclosure.

FIG. 5 illustrates another embodiment of a system of the disclosure.

FIG. 6 illustrates representative steps in a method for employing the system of FIG. 5.

FIG. 7 illustrates another embodiment of a method of the disclosure.

### DETAILED DESCRIPTION

In one aspect, the disclosure is directed to a device for determining and/or indicating a medicament dosage regime. For instance, in certain embodiments, a dosage determining and/or indicating device is provided wherein the device is configured for at least indicating when a dosage is to be administered and/or may further be configured for determining the type of medicament to be delivered, the dosage, time interval of dosing, and period during which the dosage is to be administered.

Accordingly, the dosage determining and/or indicating device may include a housing, a processor, a memory, an input device, and/or an indication device. The housing may be of any shape and of any size and is configured for containing the processor and memory and may further be configured for containing or otherwise being associated with an input and a display device, a GPS device, a gyroscope, and/or a suitable power supply. Accordingly, the bounds of the housing may directly contain one or more of the processor, memory, input device, indication (e.g., display) device, GPS device, gyroscope, and/or power supply; or one or more of these elements may be independent there from and otherwise associated with the housing and/or otherwise contained therein. For instance, in some embodiments, at least the processor and memory may be contained within a client, which client may be associated with the housing of the device.

In certain embodiments, the housing is of a shape and a size so as to be fit within the hand of a user, such as a subject in need of a medicament or a health care professional prescribing a medication. In other embodiments, the housing is configured as a medicament container having a client, as described in more detail herein below, associated therewith.

Generally, dosage determining and/or indicating device may be configured for receiving user, e.g., patient, information, medicament information, and/or dosage information, or the like, and further may be configured for using that information to determine one or more of the following: a patient characteristic, a patient symptom, the type of medicament recommended to be administered, how often and when the medicament should be administered, how much of the medicament should be administered, potential problematic cross reactivity information, and/or patient compliance information; such as where and/or when the medicament was last administered, when the medicament is next due to be administered, when a recommended administration was not administered, and the like. The dosage determining and/or indicating device may further be coupled to an alarm to indicate, for instance, when a dosage of the medicament is to be delivered and/or to indicate when a dosage of the medicament is about to be inappropriately delivered. Additionally, the dosage determining and/or indicating device may include a locking mechanism so as to prevent the administration of a dosage, such as when it would be inappropriate for such a dosage to be delivered. In certain instances, the dosage determining and/or indicating device of the disclosure may be configured as a container, such as a tablet container, as described below, and/or may be configured as a personalized computing system, such as a personal data assistant (PDA), mobile phone, computer, and the like.

By use of the term “medicament” is meant herein any formulation that is to be administered to a subject thought to be in need thereof for which the administration thereof is believed to be beneficial to a condition of the subject. In certain embodiments, the medicament may a pharmaceutical or other type of therapeutic composition, such as a drug or the like, prescribed by a health care professional. For instance, in one embodiment, the medicament is a formulation for the prophylaxis and/or treatment of an unhealthy, e.g., a disease, condition which has been formulated into tablet form, which tablets are to be administered periodically at certain dosages over a prolonged period of time. However, in some embodiments, the medicament may not be a drug but rather may be a nutriceutical or cosmetic composition, which composition need not be prescribed by a health care profession, but rather may be available as an “over the counter” formulation. In certain embodiments, the medicament may be a vitamin, ointment, salve, oil, or other formulation that is believed to have beneficial effects when applied or otherwise administered to the body.

In another aspect, the disclosure is directed to a device for containing and/or dispensing a medication, such as a medication in tablet or liquid form, wherein the device is associated with a dosage indicator, such as that described above. The device may include a receptacle, such as a container, that is configured for receiving and containing the medication for a prolonged period of time, such as in between dosages during a treatment regime, and may further be configured for dispensing a determined dosage of the medication at a determined time and/or periodicity.

The device may additionally include an opening, such as a lid, that is configured for being opened and/or closed, or otherwise removably associated with the container. In certain embodiments, one or both of the container and lid (if provided) may include the indicator, which indicator is configured for indicating one or more of: the type of medication contained, when and/or how much of the medicament is to be administered, when the container was opened, when the medicament was administered, and/or may store and indicate other pertinent patient information, such as name, age, weight, sex of the patient, patient history, health history, medication history, and/or cross reactivity information.

In certain instances, the container and/or lid (if provided) may include a GPS and/or gyroscope function so that the location and/or position of the container, especially during usage, may be determined and/or tracked. In some embodiments, the device may further include a patient identifying and/or locking mechanism that identifies the patient authorized to use the device and/or prevents the opening of the device, e.g., the removal of lid from the container, for instance, if the patient has not been appropriately identified, and/or in between the recommended dosage times, and/or if there is an unresolved, potentially dangerous cross reactivity identified, and/or it is determined that the container has been lost or stolen.

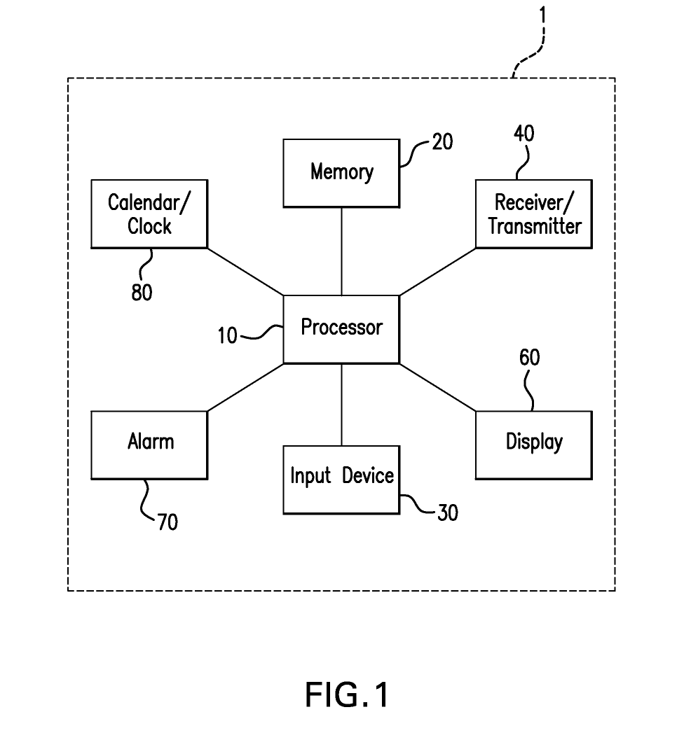

In certain embodiments, the device may include a client, which client may include a processor containing programming adapted for determining and/or indicating a dosage regime of a medicament to be administered to a particular subject in need thereof. The client may be associated with a substrate, such as a substrate of a housing, for instance, the housing of a pill container. For example, as can be seen with respect to FIG. 1, a substrate may be provided, wherein the substrate forms a portion of a housing of a device 1. The substrate may be associated with a client that includes at least a processor 10 and a memory 20. The processor 10 is coupled to the memory 20, which memory 20 includes programming configured for controlling the functioning of the device 1. For example, the memory 20 may be configured for receiving information from an external source, storing the same as data, and making that data available to the processor 10 for use thereby. Such information may be input via an input device of the disclosure 30, or via connection (direct or wireless) with an external device, such as a computer, or direct connection with the internet, e.g., via an internal modem. Other data may be entered into the memory 20 via association with one or more sensors associated with the processor 10.

An input device 30, e.g., for receiving dosage and/or user input information, may also be included. Accordingly, the memory 20 may be configured for receiving dosage and/or user input information, such as from the input device 30, and further configured for receiving data from one or more associated sensors, and storing the same; while the processor 10 is configured for receiving the dosage and/or user input information and/or sensor data from the memory 20, sorting and compiling the same for use in the various functions of the device 1. The processor may also include programming that allows the processor to receive signals and/or other data from an input device, receiver, various sensors (such as a sensor that may be included as a part of the device or used in conjunction therewith, such as in the determination of subject compliance, as described below) and to store the same in the memory.

The memory can be any type of memory capable of storing data and communicating that data to one or more other components of the device, such as the processor. For instance, the memory may be one or more of a Flash memory, SRAM, ROM, DRAM, RAM, EPROM, dynamic storage, and the like. The memory may be coupled to the processor and configured to receive and store dosage and/or user input data and/or user compliance data. For example, dosage data may include dosage information, such as: information regarding unhealthy conditions, information about various medicaments, indicating symptoms for unhealthy conditions, medicaments that are useful for the treatment of unhealthy conditions, typical dosage regimes used in treatment, dosage safety parameters, potential cross reactivities with other medicaments, and the like. The user input data may be information entered by a health care professional, pharmacist, patient, or the like, which data refers to a particular subject's personal characteristics. The data input device may be any suitable device capable of inputting data into the indicator device. For instance, the data input device may be a keyboard, a touch pad, such as on a display screen, or a receiver capable of receiving a wire or wireless transmission.

The data to be entered may pertain to general data related to various disease complications side effects, and/or symptoms, medications generally being administered for the treatment of those diseases, dosages typically being administered, and/or information regarding current health and/or sickness trends, e.g., the types of colds, flues, and the like currently being transmitted from one carrier to another, and/or current data related to potential cross reactivities between different meidicaments, and the like. Additionally, the data to be entered may pertain to a subject characteristic, such as: the age, weight, height, sex, address, ethnicity of the subject, and/or the like; a subject medical condition, such as: medical or treatment history, allergies, one or more diagnosis, medical or health conditions, list of medications currently or previously being administered; medicament information, such as: the name and type of medicament to be recommended for use, the indications and the reason for its use, its known cross reactivities with other medicaments or conditions for which such medicaments may be prescribed and the like; and/or dosage information, such as: the amount of the dosage to be administered, the periodicity of each dose to be administered, the timing of each dose, and the period during which the treatment is to occur, refilling information, and the like.

Data may also be transmitted to a memory of the device by one or more sensors. For instance, where the housing of the device forms medicament container and/or dispenser, the device may include one or more sensors that may be used to determine the opening or closing of the device, the removal of a lid there from, the removal of the medicament from the container, the location of the container, as well as the position of the container. For example, one or more proximity or contact sensors, or other suitable sensors, may be employed to determine whether a portion of the device is opened or closed or whether a lid of the device is properly associated or not properly associated with the main container body of the device. A sensor for obtaining data that may be used in determining the amount of the medicament that is contained within the device or for obtaining data that may be used in determining the amount of medicament dispensed there from may be employed, This data may adequately be obtained and transmitted to the memory by including one or more sensors that are configured for determining one or more of a pressure within the container and/or for determining a mass, weight, size, shape, density, or color of a medicament contained within the device or dispensed there from. Data related to the contents and/or amount of a medicament stored or dispensed from the device may also be obtained using one or more light sensors or appropriate metal or magnetic sensors. Other sensors known in the art may also be employed to perform these functions and thereby receive such data.

Additional sensors may also be employed. For instance, where the device comprises a housing configured for containing a medicament which is to be dispensed there from, the device may include a patient identification sensor, a location sensor, and/or a position sensor. For instance, a fingerprint pad containing a sensor for determining the identity of a user by the user's fingerprint may be employed. Such a sensor may be coupled to a locking mechanism, described below, so as to prevent the opening of the container when the appropriate user has not been identified. Additionally, the device may contain a sensor suitable for indicating the location and/or position, e.g., orientation, of the container. For example, the device may include a GPS mechanism and/or a gyroscope, both of which may be employed to provide data pertaining to the location and the orientation of the device to the processor. Such information can be used to determine where a lost or stolen container is, and/or for determining if the container has been knocked over and/or its contents spilled. Such information can also be useful for engaging the lock out feature, as described herein, and/or may be useful for evaluating whether an alarm signal should be initiated. Additionally, sensors may be used to determine the heart rate, body temperature, blood pressure, and other physiological characteristics of the user. For instance, the container could include a pressure sensor that may be used to determine heart rate and/or blood pressure, a temperature sensor used to determine body temperature, and/or other suitable sensors known in the art to perform these functions. The data obtained from these sensors may be employed to determine the identity and/or relative health of a user and/or to determine if a lock out or alarm signal should be implemented.

Accordingly, the processor may include programming enabling the processor to use one or more of the above identified data to identify a user, diagnose an unhealthy or healthy condition, such as a condition of a user, recommend a treatment therefore, recommend a medicament for use in the treatment, and/or a dosage regime to effectuate the treatment, which dosage regime may be personalized to a particular subject. With respect to dosage regime, the device may be used to determine and/or indicate when a dosage of a determined medicament should be administered, to determine subject compliance with the recommended dosage regime, and/or indicate a dangerous or potentially problematic cross reactivity with other medicaments that are being administered or may potentially be administered to the subject.

For instance, in certain embodiments, the programming may use one or more of the above data to determine a suitable dosage regime to be administered, such as: the type of medicament to be administered, the dosage, frequency of dosing, and periodicity of dosing. Additionally, the processor may include programming that is configured for determining a multiplicity of medicaments to be administered so as to treat a given condition and/or the side effects associated with the condition or other medicaments to be administered. In such an instance, the processor may include programming capable of determining the types of medications to be administered, the possible side effects thereof, the types of medicaments to be administered to reduce or ameliorate those side effects, and to indicate warnings as to possible cross reactivities and/or indications of what medicaments should not be included in a dosage regime because of potential adverse cross reactions. Once the processor has made a determination a result thereof may be communicated to a user, health care professional, or other such person via a suitable display or indicator, such as an alarm.

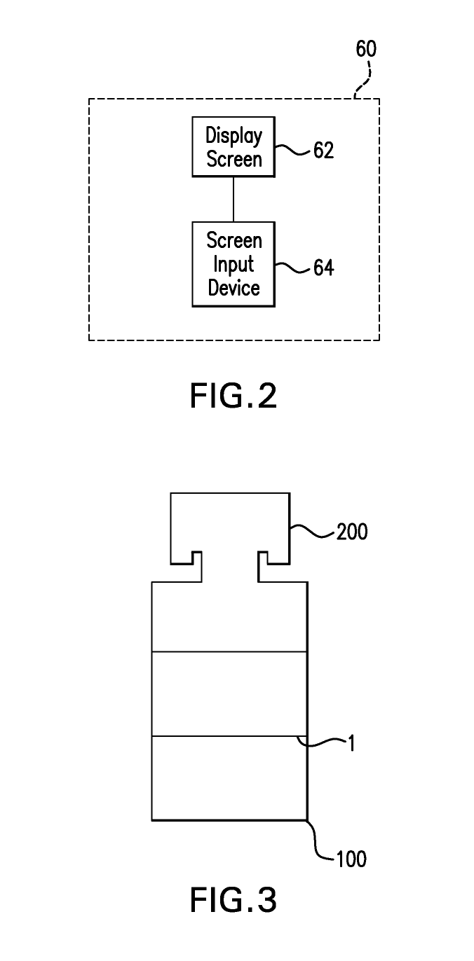

The dosage determining and/or indicating device 1, therefore, may further include display 60 and/or an alarm 70 and/or a calendar 80 that may be associated therewith. The display 60 may be any form of display capable of receiving data from the processor and displaying that data, for instance, on an output device such as a screen, e.g., an LCD, LED, and/or plasma screen. For example, the display may be configured for displaying information about the medication and when it is to be administered, etc. As can be seen with reference to FIG. 2, the display 60 may be an interactive display and include a screen 62, wherein the screen 62 may further include a touch screen input device 64. For instance, the screen may be a capacitance or resistive screen configured to allow the user to input information into the device, such as in response to a request for information.

The alarm 70 may be configured to indicate an output in any suitable manner, for example, the output may be an auditory, visual, and/or vibratory output. The device 1 may include a calendar and/or clock 80 that may be associated with an alarm and/or processor of the device. For instance, the processor may include programming that may access one or more of the calendar and clock and use the accessed information to control the alarm. For example, the processor may access the dosage determination and/or user information data and engage the alarm to indicate when a dosage should be administered, when a dosage should not be administered, when a dosage is or was missed. In this manner the dosage determining and/or indicating device may be used to indicate one or more of: when and/or how often the medicament should be administered, how much of the medicament should be administered, when a recommended administration was not administered, a potential problematic cross reactivity warnings, and/or patient compliance or in compliance warnings, and the like.

The dosage determining and/or indicating device 1 may also be configured for receiving data and transferring it to the memory, processing the same to produce an output, and/or transmitting that data to a display of the device and/or an external device, such as a computer, or to a secondary or tertiary client. For instance, the device may include wire or wireless communication capability, such as for the remote sending and/or receiving of data, e.g., a wire or wireless transmitter and/or receiver, wifi connection, infrared or bluetooth communication device, USB or SD port, flash drive port, or the like. In this regard, the processor may include programming for tracking and sending user compliance data with respect to the user's administration of a medicament or lack thereof or compliance with a dosage administration regimen. Data pertaining to the need for a refill of a prescription may also be determined by the device and forwarded to a health care professional or pharmacist for the renewal and/or refilling of the prescription.

Further, the dosage determining and/or indicating device may be configured for being associated with a receptacle that is adapted for containing a medicament and/or a lid adapted for removable association therewith. Accordingly, in one aspect, the disclosure is directed to a device for containing a medicament. The device includes a receptacle, such as a retainer, which is configured for receiving and containing a medicament, for instance, over a prolonged period of time, such as in between dosages during a treatment regime. The medicament may be in any suitable form, such as in the form of a solid, liquid, powder, suspension, of the like. Hence, the container may be in any shape or size so long as the shape and size thereof is suitable for adequately containing the form of the medicament. For instance, the container may be extended, bounded by a wall or walls, and include an lumen that is adapted for receiving and containing the medicament. For purposes of clarity, the receptacle will be referred to herein as a container which container may be in any suitable form so long as it is capable of containing a medicament and being associated with a sealing mechanism whereby access to the medicament is prevented while the sealing mechanism is associated with the container.

The container device may further include a sealing mechanism or other closure. The sealing mechanism or closure may be configured for being associated with the container and for preventing access to or spillage of a medicament that is contained within the container while the closure is associated with the container. For purposes of clarity, the closure will be referred to herein as a lid that is configured for being associated with the container. The lid may be any shape or size so long as the shape and size are capable of associating with the container so as to sufficiently contain the medicament therein. The lid may be integral with the bounds of the container and configured for opening and closing, or the lid may be separate from but configured for removable association with the container and, in some embodiments, may be tethered to the container.

The container device may also include a dosage determining and/or indicating device such as that described herein above. The dosage determining and/or indicating device may be a separate element that is capable of removably associating with one or both of the container and/or the lid, or it may be a component that is integrated therewith such as at the time of manufacture or sometime thereafter. Accordingly, the container and/or lid may serve as a housing for the dosage determining and/or indicating device described above. Hence, the container and/or the lid may include a client containing a processor and a memory containing programming as described herein above.

For instance, the container and/or lid may include a client containing processor and/or a memory associated therewith, which includes programming that is configured for receiving and storing data, determining and/or indicating information about the medicament contained, the subject to whom the medicament is to be administered, and/or the dosing and/or administration regime, and/or for performing one or more operations with respect thereto. For example, the data to be processed may pertain to user data, use data, compliance data, and the like. The information to be indicated may be one or more of: the identity of the user, the type of medication contained, when and/or how much of the contained medicament is to be administered, when the container was opened, when the medicament was administered, and/or may contain other pertinent subject information such as name, age, weight, sex of the subject, patient history, health history, medication history, and/or cross reactivity information.

Further, as indicated, the container and/or lid may include a memory that is coupled to the processor, which memory may be configured to store sensor data and other information about the medicament contained within the container, such as: the name and type of medicament to be contained, the indications and the reason for its use, its known cross reactivities with other medicaments or conditions for which such medicaments may be prescribed and the like; and/or dosage information, such as: the amount of the dosage to be administered, the periodicity of each dose to be administered, the timing of each dose, and the period during which the treatment is to occur, refilling information, and the like, as described above.

The memory of the container and/or lid may further be configured to store user compliance data, which data may include when and at what times the container is opened and/or closed, when and at what times the medicament is administered, when and at what times a recommended administration is missed, and/or the like, as described above. Such data may be entered by the user taking the medication and/or may be automatically catalogued by the functioning of the processor and its associated programming and/or transmitted to a receiving device, such as a computer at the office of a health care professional or pharmacy.

The memory of the device may also be configured for receiving, storing, and making accessible data obtained by one or more sensors of the device. For instance, the memory may store data pertaining to the opening or closing of the device, the removal of a lid there from, the removal of the medicament from the container, the location of the container, as well as the position and orientation of the container, the amount of the medicament that is contained within the device or amount of medicament dispensed there from, as well as data pertaining to one or more of pressure, mass, weight, size, shape, density, or color of a medicament contained within the device or dispensed there from. Additionally, the memory may store data pertaining to patient identification and other patient associated characteristics such as data pertaining to user heart rate, body temperature, blood pressure, and other physiological characteristics of the user. This data may be stored in the memory of the device and may be employed by the processors in the performance of its determinations and the running of its operations.

A display device, clock, calendar, timer, and/or alarm mechanism may also be included so as to generate, process, compile, and/or display the stored information and or generated user compliance data. For instance, the information that may be indicated and/or displayed may be one or more of: the type of medication contained, the designed or generated dosage regime, when and/or how much of the medicament is to be administered, when the container was last opened, when the medicament was last administered, compliance data, and/or may contain other pertinent subject information such as name, age, weight, sex of the subject, patient history, health history, medication history, and/or cross reactivity information, as described above.

The processor of the container and/or lid may also include programming and/or transmitting and/or receiving mechanisms that allow the processor to send and receive signals and/or other data from an input device, other similarly designed containers, and/or various sensors (such as a sensor that may be included as a part of the device or used in conjunction therewith, for instance, a sensor configured for sensing when the device is opened, and the like) and to store the same in a memory and/or display information pertaining thereto, for instance, on a display of the device.

For example, the container and/or lid may be configured for communicating with a user, an associated computer, other user clients, and/or other such containers and lids so as to indicate when a medicament is to be delivered, when a dosage regime is being followed or not being followed, user compliance information, and/or to transmit data back and forth between the container and/or lid and an associated computer, and/or other user clients and/or other such containers. In this manner, the container and/or lid may be configured for indicating to a user medicament information, usage, dosage, and/or compliance information, and/or cross reactivity information. For instance, the container can electronically display for the user of the container or other secondary or tertiary user and/or signal to any such user information about the medicament and its associated dosage regime and/or the compliance data associated therewith. Accordingly, the container and/or lid may further communicate with a secondary user, such as a heath care professional, to transmit user compliance data, and may further communicate with other similar containers or lids in its local environment, such as a medicine cabinet, that may contain other medicaments so as to identify and/or warn against any possible adverse cross reactions if the contained medicament is administered in conjunction with another medicament that is contained in a similar container that is also capable of such communication. In this manner the containers of the disclosure are capable of communicating with one another locally so as to warn against potential cross reactivity problems, such as by emitting a warning alarm in situations where one container identifies a potential problematic cross reaction potential with a medicament contained in another container.

As can be seen with respect to FIG. 3 a device of the disclosure may be configured as a typical medicament container for containing a medicament therein, e.g., a pill bottle (such as a prescription pill bottle), as known in the art. The container 100 and lid 200 can be made from any suitable material, such as plastic. The container 100 and lid 200 are configured for removable association with one another. As depicted, the container includes a client 1, as described above, which client at least includes a processor with programming thereon, a memory, and a communication medium. The client 1 may be removably attached to the container or fabricated so as to be structurally integral therewith. The client 1 is configured for employing the communication medium for indicating one or more of: the type of medication contained, when and/or how much of the medicament is to be administered, when the container was last opened, when the medicament was last administered, and/or may contain other pertinent subject information such as name, age, weight, sex of the subject, patient history, health history, medication history, and/or cross reactivity information. Accordingly, the client 1 may additionally be associated with or have a communication medium such as an auditory, visual, and/or vibratory mechanism that is configured for indicating information, as described herein, to a user. Hence, the client may be associated with or otherwise include a speaker, visual display, or vibration unit that is associated with the processor that includes programming specific for producing an indication in response to a user input and/or in response to an internally generated signal.

For instance, in one embodiment, the container 100, lid 200, and client 1 may be configured such that in response to a pressure applied by a user to the container 100 or lid 200, e.g., by pressing down thereon or by pressing there against, the client communicates via the communication media information to the user, such as one or more of the above identified information. For example, the communication media may emit a sound via a speaker or a vibration, so as, e.g., to communicate when a dose of the medicament is due for administration, and/or if a display is included, the information, such as e.g., the type of medication contained, may be displayed in letter, symbol, or pictorial from for a reader to see. The sound may be a prerecorded message, a computer generated message, or a simple auditory signal, such as a beep or series thereof. In another embodiment, the container 100, lid 200, and client 1 may be configured such that in response to an internal signal, such as that by the processor interacting with an included calendar, clock, or timer, in accordance with a stored dosage regime, the communication media communicates information to the user, such as one or more of the above identified information.

The device may further include one or a plurality of sensors, such as a sensor configured for determining when the lid has been removed, e.g., the container opened, and/or when a quantity of the medicament has been removed from the container. Hence, the communication media may further be adapted to indicate the opening of the container and/or the removal of a medicament from the container. The indicator can further be configured to send a signal to the primary user or secondary or tertiary user, e.g., in response to a quantity of medicament being removed from the container, so as to confirm that an administration has in fact taken place. The response thereto may then be stored in the memory and processed by the processor so as to update the dosage regime and/or compliance information, and the like. In some embodiments, as described in detail below, the device may further include a locking mechanism that prevents the lid 200 from being removed from the container 100 in between the recommended dosage times and/or if there is an unresolved, potentially dangerous cross reactivity identified, or the device is otherwise locked by the intervention of a secondary or tertiary user.

In certain embodiments, a container and/or lid of the disclosure may further include a locking mechanism that is configured for preventing the container from being opened and a medicament being dispensed there from. For instance, where the container includes a lid, the locking mechanism may be configured for preventing the lid from being removed from the container, such as in between the recommended dosage times and/or if there is an unresolved, potentially dangerous cross reactivity identified. The locking mechanism may be any suitable locking mechanism so long as it is capable of preventing the container from being opened, e.g., preventing the lid from being removed from the container, such as when a dangerous cross reactivity is identified, a potential overdoes is possible, and/or during a period where the medicament is not supposed to be administered, and/or when instructed by a secondary or tertiary user. Accordingly, the locking mechanism may be an electronic and/or mechanical mechanism as is known in the art.

The locking mechanism may be coupled to a calendar, clock, and/or timer of the device and may be controlled by programming of the processor such that the device itself regulates when the lid may be removed and when it may not be removed. In some embodiments, the opening of the container and/or removal of the lid may be regulated in response to an external signal such as from a remote commander and/or from a wireless communication module, e.g., from a secondary or tertiary user. In this manner the locking mechanism may be controlled remotely, for instance, by a health care professional in an instance wherein the health care professional or other responsible person or client deems it is unsafe for any further administration of the medicament. The container and/or lid may additionally include one or more sensors and programming configured for detecting when and/or for how long the lid is removed from the container and/or a sensor for determining the quantity of the medicament removed from the container. For instance, the container may include a sensor configured for measuring the weight of the contained medicament and programming configured for determining the amount of the medicament removed based on a decrease in the contained weight.

The dosage determining and/or indicating device, which may or may not be associated with a container and/or lid of the disclosure, may additionally include programming that is configured for providing a user interface. For instance, a device of the disclosure may include a processor, a memory, a display, and/or an input device so as to allow a user or other party to input data into a memory of the device, which data may be accessed by the processor, such as for the purpose of determining administration and/or user compliance. For example, an interactive display may be included wherein the display displays one or more questions directed at ascertaining whether an administration has occurred and/or whether the user has complied with an administration regime, and/or has beneficial or deleterious reactions thereto. This information may then be sent, e.g., via a wireless communications modem, to a receiver, such as a computer at the office of a health care professional or pharmacist. In this manner, a device of the disclosure can track the opening and closing of the container, the dosage, usage, and/or compliance with a dosage regime, effectiveness of dosage, information pertaining to subject health, and cross reactivity information, and communicate that information to a user or another party such as an authorized health care professional.

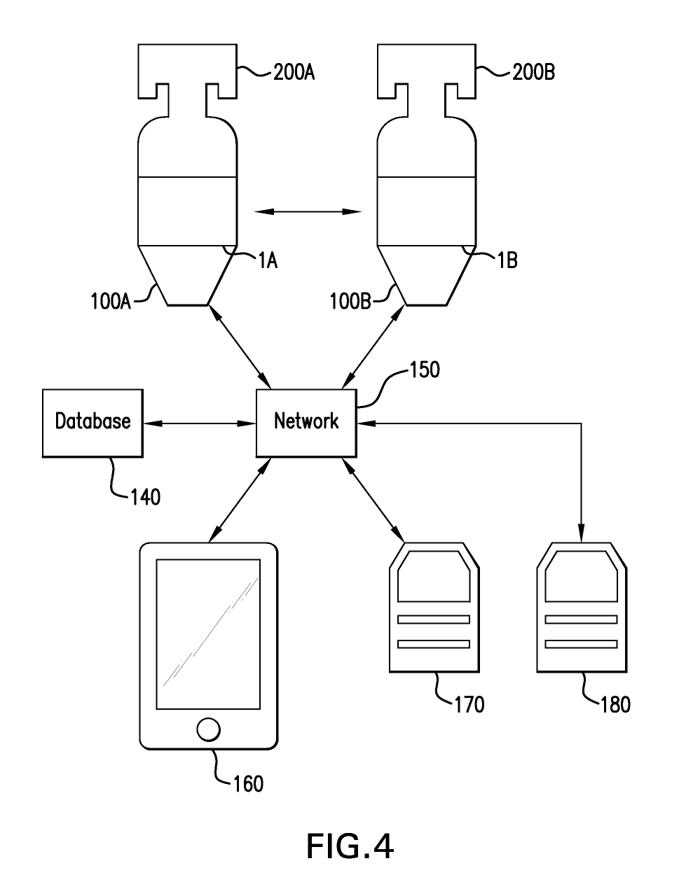

As indicated above, and set forth in FIG. 4, a container and/or lid of the disclosure may be configured so as to be able to communicate with one or more of a multiplicity of devices, such as through a network. For instance, a container 1A may be configured so as to be able to communicate with another suitable container 1B, e.g., through network 150. Further, containers 1A and 1B may be configured to communicate with one or more clients, e.g., through network 150. For example, the containers 1A and/or 1B may be configured for communicating with a primary user interface 160, such as a PDA, a mobile phone, personal computer, and the like; a secondary user client 170, such as a heath care professional; and/or a tertiary user client 180. The one or more containers 1A and 1B may further communicate with other similar containers or lids in its local environment, such as a medicine cabinet, that may contain other medicaments so as to identify and/or warn against any possible adverse cross reactions if the contained medicament is administered in conjunction with another medicament that is contained in a similar container that is also capable of such communication. In a manner such as this the one or more containers of the disclosure are capable of communicating with one another locally, and/or with other associated clients connected to one another via a network. The purpose of this communication may be for various reasons. For instance, the containers may contact one another so as to warn against potential cross reactivity problems, such as by emitting a warning or an alarm in situations where one container identifies a potential problematic cross reactions with a medicament contained in another container. Or one or more containers may communicate with a primary, secondary, and/or tertiary client. For example, a container may communicate with a primary user client so as to allow the primary user to access client data, medicament data, dosage data, usage data, compliance data, and the like. Additionally, the one or more containers may communicate with the secondary and/or tertiary clients, e.g., servers, via the network 150, for one or more of the same purposes. It is to be noted that via network 150 the primary, secondary, and/or tertiary clients may communicate with each other for one or more of the same purposes or other suitable purposes.

In another aspect, the disclosure is directed to a method for determining and/or regulating the administration of a medicament. For instance, a dosage determining and/or indicating device may be provided wherein the device includes programming configured for eliciting information pertaining to a medication, a dosage regime, a health condition, and/or the medical condition of a subject, which information may be input into the device, such as in response to a series of questions. In some embodiments, one or more of such data may already be stored on a memory of the device.

For example, in certain embodiments, a memory of the device may include stored thereon information regarding various different unhealthy conditions, the symptoms pertaining thereto, and/or the medicaments that may be prescribed for the treatment thereof as well as any potential cross reactivities and/or side effects associated with those medicaments. In such an instance, a series of questions may be presented to a user, such as a health care professional or patient, which elicit the user to identify the symptoms of the unhealthy condition and other associated information that may be used to diagnose the unhealthy condition and/or personal characteristics of the patient that may be used to recommend a dosage. This information may then be entered into the device in such a manner that once entered the programming of the device can diagnose an unhealthy condition, recommend a treatment thereof, such as a medicament to be administered, a dosage regime (e.g., an amount and frequency of usage) to be followed, and also indicate potential harmful cross reactivities. This information may be displayed for the user to see and/or be sent to an outside receiving device, such as at a health care professional's office and/or pharmacist. It is noted that the determinations made herein allow for a personalized dosage regime to be determined based on one or more of stored data and/or client entered data. Further, the device may further include the capability of connecting to external database, such as web based databases, which databases may be accessed to update one or more of the stored data of the device, such as a stored unhealthy condition data base, a medicament database, a cross reactivity data base, a patient characteristic database, e.g., including a patient's medical history, a patient's allergies, a patient's current medication usage, and the like.

In certain embodiments, the method further includes providing a container device and a lid therefore, wherein the container and the lid are removably associated with one another, and further wherein one of the container and the lid comprise an indicator for indicating the nature of a medicament and/or when a medicament should be administered. The indicator may include an alarm that is configured for indicating when the medicament is to be administered. Hence, the indicator may additionally include a processor, which processor is associated with a memory and functions in part to control the alarm. The indicator device may further include a receiving device, such as a wireless transmitter or keyboard, that is configured for receiving data and/or transferring that data to the memory. A calendar, clock, and/or timer may also be included wherein the calendar, clock, and/or timer may also be associated with the processor.

The method therefore may include opening the container, removing a medicament contained therein, and administering the medicament, such as in response to an indication, such as an alarm of the device. The method may further include employing the receiving device so as to receive data and/or an input device so as to input data into the calendar, timer, clock, and/or directly into the memory, such as subsequent to the administration of a medicament, which data may then be used by the processor to determine when an administration event has taken place, to track the opening and closing of the lid, to track administration, and/or to determine compliance with a dosage regime.

The method may additionally include signaling to a user or a remote receiver when a new prescription for the medicament is necessary. For instance, the device may include a wireless transmitter that transmits data pertaining to subject compliance with respect to a dosage administration regimen and/or communicates the need for a refill of the medicament. In certain embodiments, the method may further include engaging a locking mechanism of the device so as to prevent the further administration of the medicament, for instance, in between dosage periods or where over dosage or improper administration may occur. The locking mechanism may be engaged automatically via the programming of the processor in response to administration and/or compliance generated data, and/or by user input, and/or by remote transmission, such as by a wireless remote commander or other received code. The method may additionally include the automatic communicating of the container with another container device capable of communicating with the device in a similar manner, wherein such communication involves the exchange of data regarding medication contained within the containers and wherein if said communication results in an identification of a medicament in another container wherein the medicament would result in an adverse reaction an alarm is emitted as a warning signal or the device locks itself.

As described herein, in one embodiment, a single primary user client, a single secondary user client, and a single network is provided. However, in certain embodiments, it is understood that a plurality of primary clients may be provided. For instance, where a plurality medicament users are provided such as in a medicament usage study. In such an instance, the plurality of medicament users may be provided with a plurality of containers as described herein wherein the plurality of containers are connected to one or more secondary client users, e.g., servers, via one or more networks. The server, therefore, may include programming adapted to receive client use data and to collate, process, and transmit the same. Specifically, the use data of the population may be employed to determine relevant statistics pertaining to the compliance and/or use of the containers, and/or compliance with a dosage regime.

For example, where a plurality of primary user clients are provided the secondary user client, e.g., server, may be configured for processing and compiling the use data so as to generate statistics data, which statistics data may then be provided to one or more other user clients, e.g., a primary user client or other server. The average, mean, standard deviation, significance, variance, etc. may be determined. Further, where a plurality of primary user clients are provided, the server may be configured for compiling and weighting the use data of each user with respect to each users determined compliance data.

In this manner, the server can employ the provided data to determine the significance of each users use outcome. Hence, each user's use data may be ranked according to the weight attributed to their outcome data in view of their compliance. A compliance accuracy rating for each individual user may be determined. Accordingly, one or more clients or servers of the disclosure may be configured for compiling use and/or compliance data provided by the primary user clients. The compiling of the data provided by the primary user clients may include weighting the data, ranking the users, and generating an accuracy rating based on the compiled data. Hence, with respect to the use data, a server system of the disclosure may use the compiled data to generate an overall prediction as to how each user's compliance contributed to an effectiveness of the medicament usage.

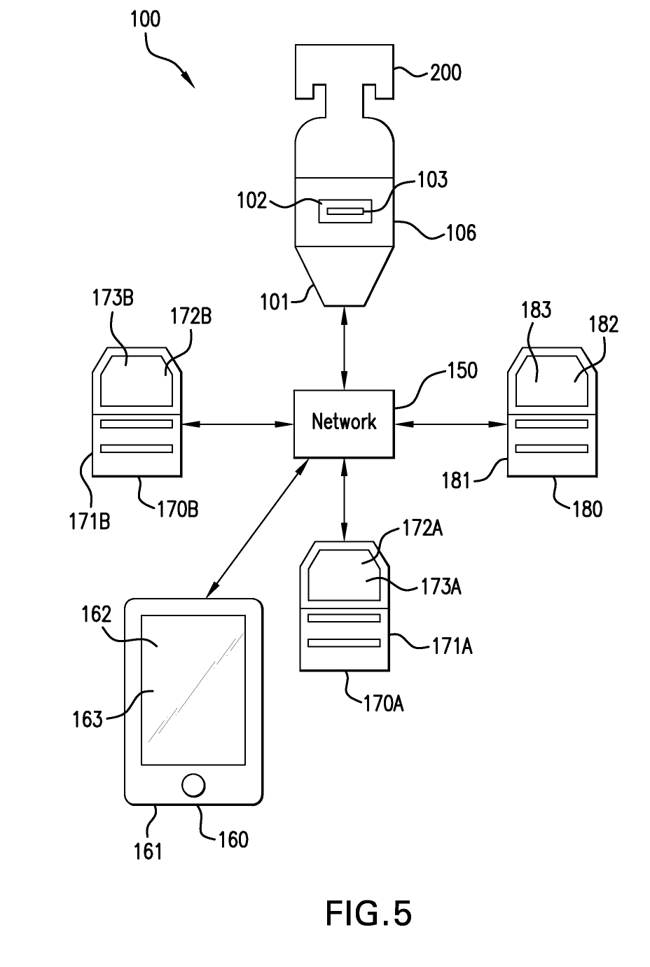

Accordingly, in an additional aspect, as set forth in FIG. 5, a system 100 is provided. The system 100 may include a device 101 for containing and/or dispensing a medication. As described above the device 101 may be a container having a lid 200 and a primary user client 106. The primary user client 106 may include a primary user interface 102 having a display upon which a page 103 may be provided. The system 100 may further include one or a plurality of additional user clients, such as clients that may include user interfaces, which user clients may be connected to the container directly and/or one another by a network. The user clients may contain a processor, memory, and programming sufficient for performing one or more of the following functions: receiving, processing, generating, and/or transmitting data and/or for performing operations associated therewith. The one or more user interfaces associated with the one or more user clients may be a display and/or other indication device. With respect to FIG. 5 a plurality of user clients are provided, the user clients may include one or more of: primary user clients 100 and 160 with a primary user interfaces 102 and 162, respectively, a secondary user clients 170A and 170B with a secondary user interfaces 172A and 172B; and a tertiary user client 180 with a tertiary user interface 182, It is to be noted that additional user clients, e.g., computers and/or servers may also be provided as part of the system 100. Each of the client user interfaces, 162, 172A-B, and 182 may be configured for displaying generated pages 163, 173A-B, and 183 respectively. Accordingly, in certain embodiments, a system 150 is provided, wherein the system 150 includes a container 101 that is associated with a primary user client 106, one or more additional user clients, e.g., an additional primary user client 160, secondary and/or tertiary user clients 170A-B and 180, and a network 150 connecting them.

The primary client user interface 102 and/or 162 may be an interface provided to a user of the container 101. The primary user interface 102 may be provided at a client 106 that is associated with the container 101. An additional primary client and/or client user interface may also be provided, for instance, an additional primary user interface 162 may be associated with a client 160 that is associated with an auxiliary device 161 of the primary user, such as a PDA (personal digital assistant), personal computer, mobile phone, and the like, One or more, e.g., a plurality, of secondary user interfaces 172A-B may also be provided at secondary clients 170 A-B, such as to various users of the data compiled and/or generated by the primary user client 106 and/or 160. In certain embodiments, the secondary clients 170A-B may access and manipulate the data provided by the primary user client 106 and/or 160, and may interact directly with the primary user client 106 at the container 101. A tertiary user interface 182 may be a user interface provided at a tertiary client 180, which user interface may have access to the data generated by the primary user client 106 and/or 160 and/or data generated by the secondary user client(s), e.g., 170 A-B. In certain embodiments, the tertiary user interface 182 may or may not have the ability to access and/or the ability to manipulate the data provided at the primary and/or secondary user clients. It is to be noted that the secondary and tertiary user clients may be associated with one or more servers, such as servers 171 A-B and 181, respectively.

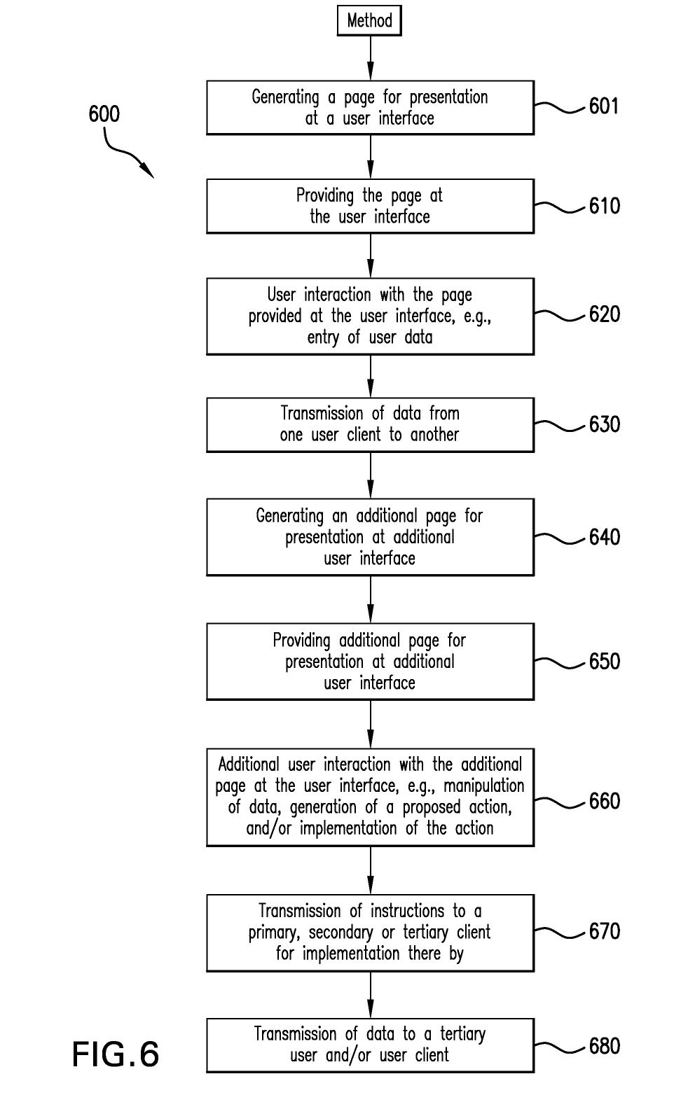

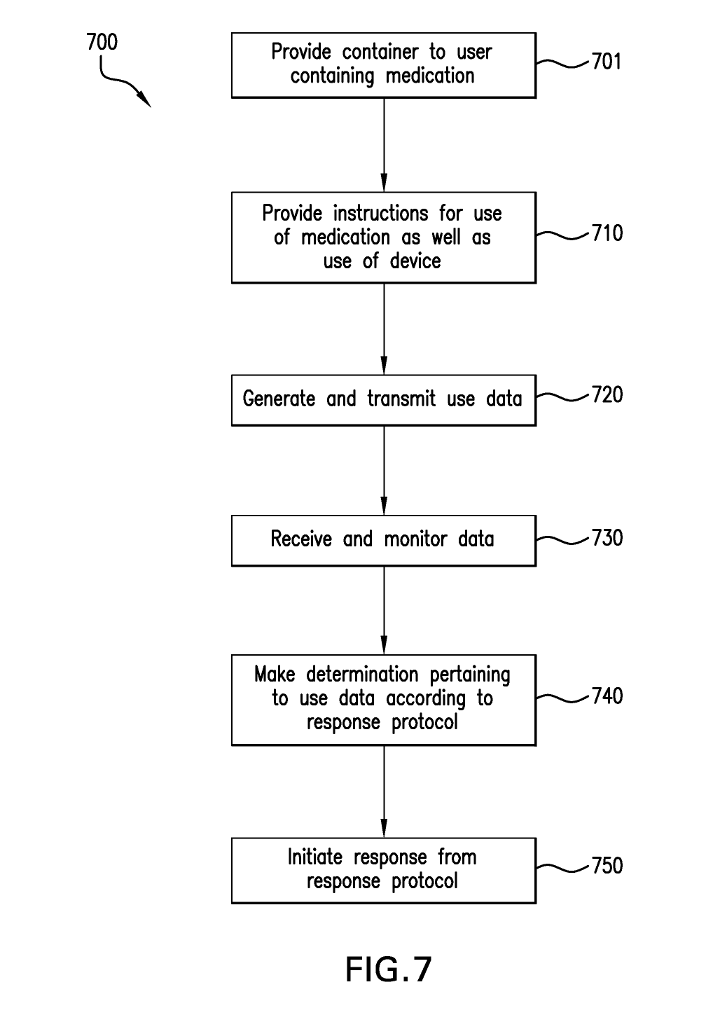

With respect to FIG. 6 a method of employing one or more portions of the system of FIG. 5 is provided, The method includes a series of steps that may be performed in any logical order. For instance, the steps may include 601 generating a page for presentation at an interface, such as at a user interface. The page may include one or more requests for data, such as data pertaining to user. The method may further includes 610 providing the generated page, for instance, at the user interface at a primary user client, thereby prompting the user, e.g., patient or other designated user, to enter data thereby. However, the page may also be generated and presented at a secondary and/or tertiary user interface as well, in which case, the data presented thereon may be different than the data presented at the primary user interface, and consequently the client or users interaction with that data may also be different, as described below.

For instance, as described with respect to FIG. 5, the page to be displayed may be generated and provided to a primary user client for presentation at a primary user interface, wherein the primary user client may be associated with a container of the disclosure, or may be provided at another suitable auxiliary device, such as a personal computer of the primary user, PDA, mobile phone, or the like. In such an instance, the auxiliary device may be configured for communicating with the container to transmit and/or receive information therewith. Hence, the method may further include a primary user interacting with the page that is displayed at the primary user interface, which user interface is provided at the primary client, e.g., container or auxiliary device. For example, the primary user client may generate one or more queries to be displayed on a page at the primary user interface, which queries act to elicit the entry of primary user, e.g., patient, information. Hence, the primary user may interact with the display and/or an associated data entry mechanism to enter data into the system e.g., in response to the generated queries.

For example, a suitable data entry mechanism may be any suitable mechanism for transmitting data, such as data entered by a user, to a memory of the device, e.g., handheld device or container, or an associated server. The data entry mechanism may be a keyboard, mini keyboard, touchpad, voice recognition device, touch screen display, and the like. Hence, a user interface, as described herein, may include a touch-screen display wherein the display presents a representation of a generated keyboard wherein data may be entered into the devices by touching or tapping on the representation of the keys.

In certain instances, the data to be entered is in response to a query elicited from the client, such as a request for user information made by the client, and displayed at the display of the user interface. The display may be of any suitable shape or size, such as a flat panel, LCD, LED, type of display. An exemplary elicitation may be, for instance, one or more of a request for: user personal information, a user preference, a user designation, a diagnosis, information regarding a medicament, its use, and its dosage, a user selection, a user confirmation, and the like. In one exemplary instance, the user input data, such as selection data, includes one or more of a confirmation regarding compliance with an administration protocol. As described, the primary user client may be configured for receiving user entered data, processing, storing the same, and/or transmitting that data to a secondary or tertiary source, such as a server system.

Accordingly, the primary user client contains programming so as to receive, determine, and/or track data pertaining to the primary user and/or the primary user's interaction with the container as well as to transmit that data to one or more secondary and/or tertiary users, such as via a network. The network may be any suitable mechanism for connecting the clients with one another or a database associated therewith, such as an intranet or an internet (which may include wired and/or wireless links). The methods of the disclosure, therefore, may also include the transmission of data 630, e.g., user information data, use data, compliance, data, sensed data, and the like, from one user client, e.g., a primary user client, to a secondary user client, e.g., a server, via a network.

Hence, where a multiplicity of user interfaces are provided, e.g., primary, secondary, and/or tertiary user interfaces that are associated with primary, secondary, and/or tertiary user clients, the method may additionally include making primary user data available to the one or more of additional user client interfaces, such as via a network. Thus, the method may include 640 generating one or more pages for presentation at an additional user interface(s) 650. In this regard, the additional user interfaces may include a user interface provided at a client at a secondary user's location, such as at a Doctor's office, health care provider's office, and the like; and/or a user interface provided at client at a tertiary user's location, such as at an insurance company, a federal or other government agency, a monitoring service, and/or the like. The one or more pages may present data to the secondary and/or tertiary user via the page and that data may be accessed and/or manipulated by the secondary and/or tertiary user, e.g., doctor's office, health care provider, etc. via the clients connection to the network. The data to be provided may be raw data or compiled data, such as data entered by a primary user of the container and/or data generated by the programming of the primary user client of the container, such as container interaction or usage data.

For instance, the data may be primary user entered data or other data generated by the primary user's interaction with the container, for instance, use data. Such use data may include one or more of: the opening and closing of the container, e.g., removal of the lid; time and/or location and/or position of the container at the time of opening or closing; the weight differential measured during the time periods between opening and closing; dosage data; attempted access data; identity of attempted accessor; biological status information of accessor (e.g., heart rate, blood pressure, body temperature, and the like); lock out data; updated and/or determined dosage data, medical data, disease data, cross reactivity data; and the like. The data may be collated and compiled by the processor of a client, e.g., a primary client, or the like, and may be provided to a secondary user client, such as a client of a monitoring entity, e.g., a doctor. The data may also be provided to the secondary user or tertiary user clients as raw data which is then processed thereby.

Additionally, the data may be processed by an external data base, such as after transmission by the primary user client but before receipt by the secondary or tertiary user clients. Hence, the data may be collated and/or compiled by the programming of the client associated with the container, an external data base, or a secondary and/or tertiary client, and then the data may be presented as statistical information, for instance, which in turn may be employed by the secondary and/or tertiary client so as to determine usage trending and/or to determine and/or manage risk factors and/or to initiate the performance of an operation and/or action. Accordingly, the method may include 660 the manipulation of the data by the secondary and/or tertiary client. Further, once the data has been appreciated and/or processed, the secondary or tertiary client may then interact 670 with the primary client so as to manipulate the functioning parameters of the container, e.g., via the primary user client and/or to evoke a specific response from an additional secondary or tertiary client or user.

Accordingly, the secondary user may employ a secondary client to not only access the data, e.g., via a secondary user interface, but may also employ the secondary client in a manner sufficient to interact with the programming of the primary user client, e.g., the client associated with the container device, so as to modify the use parameters of the container. For instance, in certain instances, a secondary user may access the data and make one or more decisions and/or take one or more actions in respect thereof, such as cause the transmission of one or more instructions from the secondary user client to the primary user client for implementation thereby. For example, the secondary user may interact with the programming of the primary client that is associated with the container via the network. Some of the instructions that may be transmitted and implemented into actions may include one or more of: changing the dosage amount, periodicity of dosage, updating stored medical, disease, and cross reactivity information, modifying opening and/or locking out parameters, changing patient identification information, and the like. In a manner such as this, a secondary user may access the data of the primary user's interaction with the container and in response thereto modify ongoing use parameters. In certain embodiments, a tertiary user may interact with the tertiary user client for the same purposes, and other circumstances, this is not the case, e.g., in certain instances, the tertiary user can only access the primary user data but may not interact with the primary user client.

Further, in certain instances, 680 it may be beneficial for the primary user client or secondary user (or secondary user client directly) to communicate with a 3^{rd} party in response to the use data or secondary user's interaction with the presented and generated data. Such an instance could occur where the primary user's usage data tracked and/or communicated by the primary client of the container signifies a particular risk or danger factor. In such an instance, the secondary user, such as a monitoring service, may analyze the obtained data, determine there is a risk to the primary user's health due to their interaction with the container, and in response thereto contact a tertiary user, e.g., governmental agency, such as a fire, police department, or other health care organization, via the network (or directly) for instance, to notify them of the determined risk factor. Of course, in certain instances, the primary client may interact directly with the 3^{rd} party without the mediation of the secondary user or secondary user client, e.g., via the network.

It is to be noted with respect to the above description, although only one container and therefore only one primary user interface and/or one primary user client is provided, in certain embodiments, a multiplicity of containers and/or primary user interfaces and/or primary user clients may be provided, and the data entered and/or generated thereby may be compiled and/or collated and provided to a secondary and/or tertiary user client via the network. For instance, a plurality of containers may be provided where the containers each contain an experimental medicament or such (e.g., placebo) which is currently undergoing examination, such as clinical evaluation. The containers, therefore, may be provided to members of the study group, and their individual and/or collective usage information, e.g., their interactions with the containers, may be tracked, determined, collated, compiled, and provided either as raw data or statistical data to a secondary user, e.g., a monitoring service, or tertiary user, e.g., a federal agency, such as the FDA. In this manner, the primary users' interaction with the containers may be tracked and controlled and/or otherwise used to determine compliance with the study parameters.

With respect to FIG. 8, in one aspect, a method for monitoring one or more primary users' interaction with one or more containers is provided. For instance, a method 700 for monitoring and/or otherwise determining a container user's compliance with a medicament usage parameter is provided. The method may include 701 providing a medicament container, as described above, to one or more users, e.g., test subjects, with instructions 710 for using the container to access the medicament and information pertaining thereto (e.g., dosage information and/or other medicament information). The method may additionally include generating use data 720 pertaining to the users use of the container and/or medication contained therein, and the transmission of the same to a secondary or tertiary party, such as a monitoring service. The method may also include 730 the receiving and monitoring of the subject's use data pertaining to the users interaction with the container by the secondary or tertiary user. Where two or more containers are provided to one or more primary users, the method may include generating interaction data (e.g., usage data) for each container and/or user and compiling and/or comparing the interaction data so as to generate usage data. The usage data may then be employed 740 to make various determinations pertaining to usage, such as to determine statistical information regarding medicament usage and compliance. The usage data may be determined, generated, or otherwise received by the programming of a client associated with the container and/or by the programming of a client of a secondary and/or tertiary user. The usage data may include the interaction of a single user with a multiplicity of containers, the interaction of a multiplicity of users with a single container, a multiplicity of users with a multiplicity of containers, or the interaction of a single user with a single container. The usage data may then be processed and/or transmitted (or transmitted and/or processed) to one or more secondary and/or tertiary users.

The monitoring may be performed for the purpose of determining usage information or as a means for ensuring appropriate operation parameters (e.g., usage) of the container by the primary user, for instance, to ensure the safety of a primary user of the container. Accordingly, the method may include the provision of a medicament container of the disclosure to a primary user of the container, e.g., a patient. The medicament container may include a primary client that is configured for determining the interactions of a primary user with the container and thereby generating usage data. The primary client may further be configured for determining or otherwise enforcing the usage parameters for the container.

The primary client of the medicament container may be associated with one or more of a secondary and/or tertiary client via a network. The primary client generates or otherwise transmits use data to the secondary and/or tertiary client. The secondary or tertiary client (and/or a secondary user or tertiary user thereof, respectively) monitors the use data, and if a predetermined event is identified, the secondary or tertiary client (or user, e.g., a live observer) responds in one of a multiplicity of ways. For instance, the initiation of a response protocol may include the receiving of use data by the secondary or tertiary client, the compiling and processing of that data to determine a result, and the comparison of that result to one or more predetermined conditions such that if the result is within the range of the predetermined conditions a response protocol is engaged. Accordingly, the method may additionally include initiating a response from a response protocol 750. A multiplicity of response may be engaged from a variety of response protocols. For example, the secondary or tertiary client (or users) may cause instructions for an alarm signal to be transmitted to the device or a third party, may cause a lock out or open signal to be transmitted to the device to ensure the lockdown or opening of the device, may contact the user of the device via phone or e-mail, or may initiate another predetermined response protocol. In this manner, the usage of the container may be monitored and/or tracked and if necessary, e.g., in times of emergency, the container can be locked down and rescue personal notified.

In some variations one or more of the following can optionally be included. The primary user interface may be provided at a plurality of primary clients. Where a plurality of primary clients is provided the secondary and/or tertiary clients (e.g., servers) compile the use data of the clients and generates outcome or result data which may then be employed to determine a specific response protocol. Accordingly, the user clients (e.g., servers) may include programming. The programming of the one or more servers may be configured so as to perform a probability assessment of the use data so as to determine the probability that an actual response is necessary, which probability may then be employed by the server or another party so as to weight and/or select the appropriate response from a protocol of responses.

For instance, where the present use data is determined to pertain to a particular predicted outcome, the use data may be weighed against past actual outcome and/or past actual response data, e.g., stored within a memory of the server, so as to determine the probability that a present response is necessary and if so which response is most appropriate. For example, where a specific use of a container is identified as a potential risk and the potential risk is assessed to be an actual risk that generates a particular predetermined response that is implemented as an actual response, and it is later determined that the potential risk and/or predetermined response either did or did not corresponded to an actual risk and/or an appropriate actual response thereto, a future potential risk and/or future suggested response (such as one that is similar to the past potential alarm and/or response that was actually implemented) may be given more or less weight, respectively, in determining whether the current situation amounts to an actual risk and/or what the current actual response should be.

In a manner such as this, a current potential risk and suggested response (e.g., selected from a protocol containing several possible responses) can be weighted to determine the probability that an actual risk is present and if so weight the potential responses thereto or to otherwise determine the appropriateness (or potential appropriateness) of the available responses. The determination of which response will be most appropriate and/or actually implemented may be performed as an actual selection, e.g., by the secondary or tertiary client, that is implemented automatically; or it may be provided to a user of the secondary and/or tertiary client as a suggestion, which may then be implemented by the user (e.g., by acting on their own or by interacting with the secondary or tertiary client to implement the suggested response).

In an interrelated aspect, the system as described above is provided. The system includes a primary client having a primary user interface and at least a secondary client having a secondary user interface. The primary client is associated with a container, such as a pill container. The primary client can be any suitable device for generating and/or displaying a generated page at a user interface, such as those commonly known in the art, including a computer, an electronic game counsel, a telephone, a personal data assistant (PDA), and the like. The primary client may be configured for receiving user entered data, generating use data, processing, storing the same, and/or transmitting that data to and/or receiving data (e.g., instructions) from the secondary client, e.g., a server. Accordingly, the system may include a secondary client that is a server. The server may be implemented as one or more processors, such as a computer, a server, and the like. The primary client may be coupled to the server through a network. The server is configured for receiving data from the primary client, processing and/or correlating that data, and using that data so as to determine and/or implement a response from a response protocol. The response may be any appropriate type of response, such as the transmission of a communication, such as an instruction or series of instructions, the signaling of an alarm, the initiation of an action, or the request for a secondary user instruction prior to the implementation of an action. Hence, the response may be automatically initiated by the server, e.g., as an instruction sent via the network to the primary client so as to effectuate a change therein, or the response from the response protocol may simply be to suggest an appropriate response and present that suggestion at a user interface of the secondary client and/or request secondary user confirmation before initiating the suggested response action. The system may additionally include a tertiary client that may also be coupled to the server system through the network.

For instance, in one implementation a system is provided wherein the system includes at least one processor and at least one memory. The at least one processor and the at least one memory provide operations. The operations provided include generating a page for presentation at one or more user interfaces. For instance, the page may include queries, or answers to the same, or use data, or a suggested response data, or the like. The operations further include providing the generated page and receiving input in response thereto. The operations may additionally include the implementation of an action in response to the input data. The implementation of an action in turn may effectuate a change in the memory of a client, which in turn can effectuate a change in the operation of that client, and consequently a modification of future actions governed by that client.

In another interrelated aspect, a computer readable medium is provided. The computer readable medium may contain code, which when executed by a processor provides the operations. The operations provided include those described above, such as the generating a page for presentation at a user interface, the receipt of input in response thereto, and the implementation of actions in response to the input data.

Accordingly, the implementation of the methods of the disclosure may include: the use of one or more clients (which may comprise one or more of a processor and memory, computer, a telephone, a personal data assistant (PDA), a server, or the like), upon which the generated page is displayed; a server; and/or a network connecting the client and/or the server. Hence, articles are employed herein that comprise a tangibly embodied machine-readable medium embodying instructions that, when performed, cause one or more machines (e.g., containers, computers, etc.) to result in operations described herein. Similarly, computer systems are also provided that may include a processor and a memory coupled to the processor. The memory may include one or more programs that cause the processor to perform one or more of the operations described herein.

As set forth above, the device may further include an output mechanism configured for indicating one or more of the type of medicament contained, when the medicament is to be taken, the number of times the cap has been removed, the number of times the medicament has been administered in a 24 hour period, the last time the medicament was administered, and the next time the medicament is to be administered, and thus the method may additionally include the step of responding to one or more of the above so as to comply with a dosage regime.

The systems and methods disclosed herein may be embodied in various forms including, for example, a handheld device or other container that may include a data processor, such as a computer that also includes a database, digital electronic circuitry, firmware, software, or in combinations of them. Moreover, the above-noted features and other aspects and principles of the present disclosed embodiments may be implemented in various environments. Such environments and related applications may be specially constructed for performing the various processes and operations according to the disclosed embodiments or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the disclosed embodiments, or it may be more convenient to construct a specialized apparatus or system to perform the required methods and techniques.

The systems and methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Although the description above refers to a client and/or a server, other frameworks and architectures may be used as well. For example, the subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components.

As used herein, the term “user” may refer to any entity including a person or a computer.

The foregoing description is intended to illustrate but not to limit the scope of the invention, which is defined by the scope of the appended claims. Other embodiments are within the scope of the following claims.

1. A container device for containing or dispensing a medicament, wherein the device comprises:
(a) a receptacle configured for containing the medicament, and
(b) a lid removably associated with the container, wherein one or both of the container and the lid comprise an indicator for indicating one or more of the following: the type of medicament contained, how often the medicament should be administered, how much of the medicament should be administered, when the container was last opened, when the medicament was last administered, and when the medicament is next due to be administered.

2. The container of claim 1, wherein the indicator comprises a processor.

3. The container of claim 2, further comprising a memory associated with the processor.

4. The container of claim 3, further comprising a receiving device configured for receiving data and transferring that data to the memory.

5. The container of claim 4, further comprising an input device configured for entering data into one or more of the memory and/or the receiving device.

6. The container of claim 5, further comprising a display, configured for displaying information about the medication and when it is to be administered.

10. A method for regulating the administration of a medicament, comprising providing a container device and a lid, wherein the container and the lid are removably associated with one another, and further wherein one of the container and the lid comprise an indicator for indicating one or more of the following: the type of medicament contained, how often the medicament should be administered, how much of the medicament should be administered, when the container was last opened, when the medicament was last administered, and when the medicament is next due to be administered.

11. The method of claim 10, wherein the device further comprises a receiving mechanism configured for receiving data and transferring that data to the memory.

12. The method of claim 11, wherein the device further comprises an input mechanism configured for entering data into one or more of the memory and the receiving device.

13. The method of claim 12, further comprising engaging the input device so as to enter data into the memory.

14. The method of claim 13, wherein the data to be input comprises information as to when a medication is to be taken.

15. The method of claim 14, wherein the device comprises an alarm that signals when the medicament is to be administered.

16. The method of claim 15, wherein the alarm signals when a new prescription for the medicament is necessary.

17. The method of claim 25, wherein the device further comprises a wireless transmitter.

18. The method of claim 17, wherein the wireless transmitter transmits data pertaining to subject compliance with respect to a dosage administration regimen.

19. The method of claim 18, wherein the device further comprises a locking mechanism, wherein the locking mechanism is configured for locking the cap to the container between administrations.

20. The method of claim 19, wherein the device further comprises an output mechanism configured for indicating one or more of a type of medicament contained, when the medicament is to be taken, a number of times the cap has been removed, a number of times the medicament has been administered in a 24 hour period, a last time the medicament was administered, and a next time the medicament is to be administered.
